(19) United States
(12) Patent Application Publication
(10) Pub. No.: US 2002/0142078 A1
(43) Pub. Date: Oct. 3, 2002

(54) High temperature method for browning precooked, whole muscle meat products

(76) Inventor: Prem S. Singh, Glenellyn, IL (US)

Correspondence Address: CHRISTIE , PARKER & HALE, LLP, P.O. BOX 7068, PASADENA, CA, 91109-7068, US

(21) Appl. No.: 09/772,100

(22) Filed: Jan. 26, 2001

(51) Int. Cl. A23L 1/27

(52) U.S. Cl. 426/250

(57) ABSTRACT

Disclosed is a method of producing a crisp surface and imparting a uniform golden-brown to mahgony-brown color to a precooked whole muscle meat product by coating at least a portion of the surface of the precooked whole muscle meat product with a browning liquid pyrolysis product. The coated surface is then exposed to a temperature greater than about 400° C. for a time sufficient to selectively heats the coated surface of the precooked whole muscle meat product and develop a golden-brown color on the exposed surface, without substantially shrinking the precooked whole muscle meat product.

### BACKGROUND OF THE INVENTION

1. Field of the Invention

This invention relates to a method of preparing food products. In particular, it relates to an improved method for browning precooked, whole muscle meat products.

2. Description of Related Art

Consumers' demand for precooked, prebrowned whole muscle meat products having the same appearance, texture, taste, flavor and other organoleptic characteristics as whole muscle meat products naturally smoked or baked or roasted in a home-style oven has been increasing. Consumers prefer precooked products which offer the visual and taste experience of the food they prepare at home. For example, there are some whole muscle meat products cooked in netting, in part to give a pleasing, patterned appearance to the products' browned surfaces.

In addition, consumers today are increasingly conscious about the nutritional value and wholesomeness of the products they eat. Therefore, successful precooked, whole muscle meat products satisfying the sophisticated consumers of today must not only be convenient and affordable, but must, to the greatest extent possible, give the eating experience associated with home-cooked foods and must be wholesome and safe.

There are numerous methods for browning precooked, whole muscle meat products. Frying in various kinds of edible seed oil, such as peanut oil, cotton seed oil, corn oil, coconut oil, sunflower oil, etc. is the most popular method of browning the surface of precooked, whole muscle to give the desired brown color, crispy texture and flavor to the product. Frying usually is done in oil having a temperature ranging from about 150° C. to 230° C. Production of desired color, flavor and texture is accomplished by the well-known Maillard Browning Reaction as the common elements of the whole muscle meat products, such as amino acids, sugars, collagen and minerals, react in a complex manner.

Another conventional approach to browning precooked, whole muscle meat products begins with the application to the surface of the meat products of certain browning liquids produced by pyrolyzing wood or cellulose, i.e., “liquid smoke.” These pyrolysis products are intended to develop a brown color on the product surface when the coated product is heated for about two hours to six hours in a batch-type oven with air-circulation at a temperature of from about 50° C. to 100° C. or for about ten to forty-five minutes in a circulating air oven, or in an impingement air oven at a temperature from about 120° C. to 320° C.

However, significant drawbacks remain with the conventional method of browning whole meat muscle products. After being heated to temperatures of from about 120° to 320° C., the meat products lose a significant amount of water, which can adversely affect their taste and appearance.

Further, the uniformity of browning obtained with the pyrolysis products and the retention and stability of the brown coating, as well as the color itself, is less than desirable. Still further, because the whole meat muscle products are heated at elevated temperatures for relatively long periods of time, the growth of microbes may be facilitated, thus potentially decreasing the shelf-life of the browned whole muscle meat products. It is a further disadvantage of heating whole meat muscle products at elevated temperatures for relatively long periods of time that large amounts of heat are captured by the product. The product must then be chilled, i.e., the large amount of heat removed. Typically, chilling requires a lengthy, capital-intensive chill tunnel with attendant high operating costs.

These problems can be exacerbated when the product is precooked in a net. During cooking, the netted pattern will penetrate or “dig in” into cooked meat to leave the desired pattern on the surface. When the netting is removed, however, it can leave rough, jagged edges projecting from the surface. These edges tend to char and burn when the precooked product is browned using conventional techniques.

An improved method of consistently producing a desirable, uniform, brown color, which is comparatively efficient and rapid, is as described in Singh U.S. Pat. No. 5,952,027. This process can not only produce a consistent golden-brown color which consumer likes, but is also relatively efficient, because it exposes the whole muscle meat product to an energy source that selectively heats the product surface in a way that produces the desired golden-brown color. The patent describes heating the meat product in an environment having a temperature greater than about 60° C., preferably from about 100° C. to about 290° C., and most preferably from about 150° C. to about 260° C. While this method provides significant advantages over other methods of browning precooked whole muscle meat products, improvements to this process are desirable. In particular, it remains a desideratum for a further improved process that still further reduces the amount of heat captured by the product, and thus reduces the amount of heat that must be removed, while producing the crisp surface and imparting the uniform golden-brown to mahogany-brown color expected by consumers.

Thus, there remains a definite desire for a further improved method for browning precooked, whole muscle meat products, including products having edges that are highly susceptible to burning and charring, such as products precooked in netting, to produce products having the appearance, texture, taste, flavor, and other organoleptic characteristics of their naturally smoked or home-style baked or roasted counterparts. There remains a further desire for an improved method for crisping and browning the surface of precooked, whole muscle meat products without deep frying. There also remains a desire for an improved method for crisping and browning the surface of precooked, whole muscle meat products that does not cause the products to shrink and the interior to become dried-out. There also remains a desire for an improved method for preparing whole muscle meat products having a uniform golden-brown to mahogany-brown color that is stable and retained throughout the life of the product. There remains a still further desire for an improved method for crisping and browning a whole muscle meat product that does not adversely affect the shelf-life of the meat product and does not require the removal of great amounts of heat to chill the product. The present invention satisfies these and other requirements and provides other related advantages.

### SUMMARY OF THE INVENTION

The present invention, which addresses the above desires is embodied in a method of producing a crisp surface and imparting a uniform golden-brown to mahogany-brown color, without burning or charring, that is stable and retained throughout the life of a precooked, whole muscle meat product without imparting an objectionable smoky flavor, without forming an oily surface, without substantially shrinking the meat product, and without adversely affecting the shelf-life of the meat product, but instead increases the shelf-life and improves the sensory quality of the product. In some embodiments, a precooked whole muscle meat product, including a poultry product such as a turkey breast, a chicken breast, or chicken nugget, ham, pork, or fish, is predried to remove free water from its surface. In accordance with the inventive method, at least a portion of the surface of the precooked whole muscle meat product is coated with a browning liquid pyrolysis product. The coated surface is then exposed to an energy source that creates an environment having a temperature greater than about 400° C., preferably between about 425° C. and 700° C., most preferably between about 450° C. and 650° C., for a time sufficient to selectively heat the coated surface and develop a golden-brown to mahogany-brown color on the exposed surface, without burning or charring and without substantial shrinkage of the precooked, whole muscle meat product.

In some embodiments the energy source is an infra red energy source and in some embodiments the whole muscle meat product is exposed to the energy source for three minutes or less or, preferably, for one minute or less. And in some embodiments, the temperature at the core of the meat product is initially less than about 5° C., while after the meat product has been browned, the temperature at the core of the meat product is no more than 6° C., preferably no more than 5° C.

The browning liquid pyrolysis product may be obtained from the pyrolysis of hardwoods or sugars, including dextrose, and from about 0.05 to about 1.0 wt. %, based on the weight of the precooked, whole muscle meat product, of the browning liquid is applied to the surface of the meat product. Also in some embodiments, the browning liquid pyrolysis product contains a masking agent or flavoring enhancing composition. Where the whole muscle meat product is a turkey breast, the browning liquid pyrolysis product contains from about 0.5 to about 15 wt. % turkey flavor or turkey broth or a mixture of the two as the masking agent or flavoring enhancing composition.

Other features and advantages of the present invention will become apparent from the following detailed description, which illustrates by way of example, the principles of the invention.

### DETAILED DESCRIPTION OF THE PREFERRED EMBODIMENTS

A variety of whole meat muscle products can be advantageously browned in accordance with the invention. Representative whole meat muscle products include poultry, meat, and fish products, such as turkey breasts, chicken breasts, chicken nuggets, ham, pork, and the like. The process is particularly useful in preparing deli-type, ready-to-eat, whole meat muscle products, such as the turkey breast, chicken breast, ham and like products that are sliced by deli counter operators just prior to sale to a consumers. Such products can be made of multiple small whole muscle pieces joined together by further processing to create the appearance of a whole muscle meat product formed from a single large piece.

In some embodiments, the raw, whole meat muscle is injected with a solution containing salt, dextrose, tri-sodium polyphosphate, flavorings, and sodium nitrite, if the product is to be “cured”. The amount of solution injected into the whole muscle meat product varies from zero to about 80%, based on the initial weight of the whole muscle meat product.

After injection, the whole muscle meat product is tumbled or massaged. Modem tumblers for meat processing are stainless steel drums, which rotate with slip and slice effect. The tumbling process is a physical process of transferring sufficient energy into injected muscle meat or muscle pieces to facilitate the uniform distribution of injected solution. Tumbling improves the ability of the muscles to be formed or shaped as required of deli-type products after cooking and chilling. The tumbling process makes the individual whole meat muscle pieces pliable or moldable and soft so that the surfaces of the adjacent pieces can be formed seamlessly in cook-in-bags or in molds. If the whole meat muscle pieces are not massaged, the pieces might not adhere to each other resulting in an unacceptable product and excessive purge and loss in yield.

Furthermore, to create a meat protein surface suitable for bonding the muscles together, a portion of salt soluble protein in the muscle must be extracted. Tumbling or massaging will sufficiently extract enough protein from the meat to create a tacky protein matrix on the surfaces of the muscle, which forms the strong bond during cooking and chilling jointing the muscles together.

Additionally, tumbling or massaging causes the fragmentation of muscle fibers. This fragmentation or disassociation of meat muscle fibers on the surface of muscle pieces helps in adhering or unifying during further cooking and chilling. In some embodiments, after injection and tumbling, the whole meat muscle product is stuffed in a netting bag. The netting bag produces an attractive pattern on the surface of the whole meat muscle product after cooking.

Suitable netting materials are available in rolls, presown or clipped pieces and mandrels for large capability high speed processing. Suitable netting materials are well known in the art. Representative materials include cotton and polymeric materials. Polymeric materials have the advantage that they expand during cooking when the meat expands, but do not return to their original size during chilling when the meat contracts. This makes the polymer netting easily removable without loss of meat protein layer. Preferred polymeric netting materials include polyester/rubber materials, such as elastic latex rubber fiber based netting.

After massaging or tumbling and stuffing into netting bags, the whole meat muscle product is placed in a polymeric cook-in-bag, under vacuum, and sealed. Alternatively, the whole muscle meat product is formed in a mold. The product is then placed on a rack in a smoke house or steam box or circulating air oven and cooked to a predetermined temperature, typically in the range of from about 68° C. to 74° C. Once cooking is completed, the product is chilled by showering with cold water followed by cooling with chilled air to reduce its equilibrium temperature to less than about 4.4° C. The thus precooked, chilled whole muscle meat product is then removed from the cook-in-bag or from the mold.

In some embodiments, the precooked, whole muscle meat product is then placed on a continuously moving conveyor and transported past a hot(e.g., from about 32° C. to 100° C.) water shower or steam for a period of from about ten to thirty seconds. The showers remove the gelatin purge formed on the surface of the meat product during cooking. It has been found that the inventive method is more effective if the browning liquid pyrolysis product it applied directly to the surface of the whole muscle meat product and not to an intermediate gelatin layer. Direct application promotes penetration of the browning liquid pyrolysis product into the meat tissue and facilitates the subsequent Maillard Browning Reaction.

In one embodiment, after the gelatin purge is removed, the meat product is predried by, for example, circulating hot air around the product. It is also been found that when the free water on the surface of the meat product is removed by predrying, the Maillard Browning Reaction is enhanced.

At least a portion of the surface of the thus dried, precooked, whole meat muscle product is then coated with one or more suitable browning liquid pyrolysis products, such as the browning liquid pyrolysis products commercially available from Red Arrow Products Company, Inc. of Manitowoc, Wisconsin, described in Hollenbeck U.S. Pat. No. 3,106,473 and Underwood U.S. Pat. Nos. 5,397,582, 5,292,541, 5,039,537, 4,994,297, 4,876,108, which patents are herein incorporated by reference. Products useful in accordance with the inventive method include browning liquids obtained from the pyrolysis of hardwoods such as ST-300 liquid smoke and Select 24P liquid smoke, both available from Red Arrow Products Company, Inc., as well as browning liquids obtained from the pyrolysis of sugars such as Maillose caramel coloring, also available from Red Arrow Products Company, Inc.

The optimum concentration of the commercially available products varies depending on the particular browning liquid pyrolysis product, the particular whole muscle meat product to be treated, the particular conditions for the Maillard Browning Reaction, and the desired final color. For example, Maillose without any dilution up to about 80 vol. % dilution with water can be used. The higher the concentration of the Maillose or other browning liquid pyrolysis product, the darker brown the final, whole meat muscle product will be, i.e., as the concentration incenses the final color can be caused to change from a golden-brown to mahogany brown.

In some embodiments, a masking agent or flavoring enhancing composition is included with the browning liquid. If, for example, the meat product is a precooked turkey breast, from about 0.5 to about 15 wt. % turkey flavor or turkey broth or a mixture of the two can be added to the browning liquid. Honey and other flavors can also be added to the browning liquid to give a roasted aroma and enhance the flavor of the final product.

The browning liquid is applied to at least a portion of the surface of the precooked, whole muscle meat product by any suitable method, such as by dipping, brushing or spraying. The amount of browning liquid to be applied to the surface will depend on the particular combination of browning liquid, meat product, and color desired. Typically, the amount of browning liquid ranges from about 0.05 to about 1.0 wt. %, preferably from about 0.1 to about 0.8 wt. %, and more preferably from about 0.15 wt. % to about 0.3 wt. %, based on the weight of the precooked, whole muscle meat product. The amount will be readily determinable by one skilled in the art without undue experimentation. The surface of the meat product is then browned and crisped using an energy source that selectively heats that surface. In preferred embodiments, the whole muscle meat product is placed on a continuously moving conveyor, which passes through an energy source that creates an environment having a temperature of greater than 400° to selectively heat the treated surface. Preferred energy sources include infra red sources. The energy source selectively heats and dehydrates the surface of treated meats by creating an environment having a temperature greater than 400° C., preferably between about 425° C. and about 700° C., more preferably between about 450° C. and about 650° C. In those embodiments where the precooked meat product has been kept at its chilled equilibrium temperature of less than about 5° C., selective heating allows the core of the meat products to remain at a temperature no more than 6° C. and preferably no more than 5° C.

The surface of the treated meat product is selectively heated and dehydrated by exposing the surface to the energy source for a short period of time, preferably for three minutes or less, and more preferably for one minute or less. In accordance with the inventive process, even at these extreme temperatures there results a crisp surface having a consistent, golden-brown to mahogany-brown color without any charring or burning on the surface, including the protruding surface portions of products precooked in netting, and without significant moisture loss. In accordance with this invention, the moisture loss will be less than 4% and in some embodiments less than 2% and even less than 1%. Consequently, by using these elevated temperatures. precooked whole muscle meat products, including meat products which are precooked in netting, are produced which have the desirable crispy golden-brown to mahogany-brown appearance, without burning or charring of their surface and without imparting an oily taste to the surface, all without significant moisture loss and with a minimum heat captured by the whole muscle meat product.

The following examples are included to illustrate the invention. They are not limitations thereon. All percentages are based on weight unless otherwise clearly indicated.

### EXAMPLE 1

Approximately 2000 lbs. of boneless, skinless turkey breasts obtained from fresh young turkeys were received at 4.4° C. from a producing plant. The turkey breasts were inspected and injected with 38% of a solution containing 83% water, 4.7% salt, 1.6% sodium tri-polyphosphate, 7.3% starch, 2.7% dextrose, and 0.9% flavorings. The injected turkey breasts were tumbled for 2½ hours under vacuum and the breasts packaged in polymeric cook-in-bags under vacuum. The average weight was 9.5 lbs. per package. The vacuum packaged turkey breasts were then cooked in an oven with 100% relative humidity for approximately 5½ hours. The cooking schedule was:

| | Dry Bulb | Wet Bulb | |
|---|---|---|---|
| Time | Temperature | Temperature | Relative Humidity |
| 1 hour | 55° C. | 55° C. | 100 |
| 1 hour | 60° C. | 60° C. | 100 |
| 1 hour | 72° C. | 72° C. | 100 |
| 2 hours | 79° C. | 79° C. | 100 |
| Continued until the | | | |
| internal temperature | | | |
| reached 72° C. | | | |

The turkey breasts were showered with cold water for initial chilling and then placed in an air chilled room and chilled to 4.4.° C. After chilling, the breasts were taken out of their cook-in-bags and the gelatin purge was removed by spraying the breasts with hot water. The turkey breasts then were coated with a 30% by weight aqueous solution of Maillose. (Red Arrow Products Company, Manitowoc, Wis.) The liquid pick up during coating was about 0.2% by weight based upon the uncoated meat. The coated turkey breasts were then placed on a continuous belt passing through an energy source comprised of an array of radiating metal tubes that emitted infrared energy around the product. The energy source produced temperatures of 635° C. at the top of the product, 509° C. at the bottom, below the belt, and 631° C. on the left and right sides of the turkey breasts.

After heating for 60 seconds, the turkey breasts exhibit a desirable, consistent golden-brown color and crispy, dry surface. The product loss was less than 2% by weight and there was no charring. The temperature rise below 1″ from the surface was only about 4° C.

The product was cooled to 4.4° C. The following color indices were obtained using Hunter Lab Color Meter.

Hunter Color Indices

| | L* | A* | B* |
|---|---|---|---|
| Control | 81.84 | 2.58 | 16.02 |
| (no treatment) | | | |
| Treated surface and | 56.78 | 13.30 | 39.16 |
| browned | | | |

### EXAMPLE 2

Turkey breasts were injected with 38% of a solution as described in Example 1. The turkey breasts were then placed in netting and stuffed in polymeric cook-in-bags under vacuum and the packages sealed. The thus packaged turkey breasts were cooked as described in Example 1 above. After cooking, the turkey breasts were showered with cold water and further chilled to 4.4° C. in blast chillers.

After chilling, the cook-in-bags were cut open and the netting removed. After removing the netting, the product surface had the desired geometrical pattern, but also had projecting or protruding edges. The gelatin purge was removed and the turkey breasts were submerged for 30 seconds in a 52% aqueous solution of Red Arrow Special Smoke #9936. (Red Arrow Products Company, Manitowoc, Wis.) water

The product was placed on a continuous belt having elongated gas-fired tubes positioned equally from its top, bottom, and right and left sides. The tubes were placed parallel to the direction of the movement of the belt. Two turkey breasts were loaded across the width of the belt. These tubes radiated energy so that the environment around the product was 550° C. at top, bottom and side of the turkey breasts.

The oven parameters were:

Product weight: 9.5 pounds average after removing net and cook-in bag

Product dimension: 9″ long, 8″ wide, 5-½″ high

Oven belt width: 24″

Product spacing: 2 across on 12″ center 15″ distance from row to row

Belt speed: 7′/minute

Temperature set point: 550° C./550° C./550° C. Top/bottom/side

Steam: 100. p.s.i.g.

The product loss during browning was less than 2%. The browned turkey breasts had a very good uniform color and had no charring of the protruded edges. The Hunter Lab Color Meter reading for browned turkey breasts were:

Hunter Color Indices

| | L* | A* | B* |
|---|---|---|---|
| Treated surface and | 50.99 | 10.70 | 33.77 |
| browned | | | |

While the invention has been described in connection with its preferred embodiments, it will be understood that it is not intended to limit this invention thereto, but it is intended to cover all modifications and alternative embodiments falling within the spirit and scope of the invention as expressed in the appended claims.

I claim:

1. A process for browning precooked, whole muscle meat products comprising:
coating a browning liquid pyrolysis product onto at least a portion of the surface of whole muscle meat product; and then
exposing the coated surface to an energy source creating an environment having a temperature greater than about 400° C. for a time sufficient to selectively heat the coated surface of the whole muscle meat product and develop a golden-brown to mahogany-brown color on the exposed surface, without substantial shrinking the precooked, whole muscle meat product.

2. The process in accordance with claim 1 wherein the precooked, whole muscle meat product is selected from poultry, meat, and fish products.

3. The process in accordance with claim 2 wherein the precooked, whole muscle meat product is a precooked turkey breast or a precooked chicken breast.

4. The process in accordance with claim 2 wherein the browning liquid pyrolysis product is obtained from the pyrolysis of hardwoods or sugars.

5. The process in accordance with claim 4 wherein the browning liquid pyrolysis product is obtained from the pyrolysis of dextrose.

6. The process in accordance with claim 4 wherein the amount of browning liquid ranges from about 0.05 to about 1.0 wt. %, based on the weight of the precooked, whole muscle meat product.

7. The process in accordance with claim 6 wherein the amount of browning liquid ranges from about 0.1 to about 0.8 wt. %, based on the weight of the precooked, whole muscle meat product.

8. The process in accordance with claim 2 further comprising the browning liquid pyrolysis product contains a masking agent or flavoring enhancing composition.

9. The process in accordance with claim 3 further comprising the browning liquid pyrolysis product contains from about 0.5 to about 15 wt. % turkey flavor or turkey broth or a mixture of the two.

10. The process in accordance with claim 2 wherein the energy source is an infra red radiation source.

11. The process in accordance with claim 10 wherein the energy source selectively heats the surface of the meat product by creating an environment having a temperature from about 425° C. to about 700° C.

12. The process in accordance with claim 11 wherein the energy source selectively heats the surface of the meat product by creating an environment having a temperature from about 450° C. to about 650° C.

13. The process in accordance with claim 1 wherein the coated surface is exposed to the energy source for one minute or less.

14. The process in accordance with claim 2 further comprising prior to exposing the meat product to the energy source, the temperature at the core of the meat product is less than about 5° C. and immediately after browning the meat product, the temperature at the core of the meat product is less than about 8° C.

15. The process in accordance with claim 13 wherein prior to exposing the meat product to the energy source, the temperature at the core of the meat product is less than about 5° C. and immediately after browning the meat product, the temperature at the core of the meat product is less than about 5° C.

16. A process for browning a precooked chicken breast or a turkey breast comprising:
coating at least a portion of the surface of a chicken breast or a turkey breast with from about 0.05 to about 1.0 wt. %, based on the weight of the breast, of a browning liquid pyrolysis product obtained from hardwoods or sugars to a breast; and then
selectively heating the coated surface of the breast in an environment having a temperature greater than about425° C. with energy provided by an infra red radiation source for one minute or less.

17. The process in accordance with claim 16 wherein the precooked breast is a precooked turkey breast.

18. The process in accordance with claim 17 wherein the browning liquid pyrolysis product is obtained from the pyrolysis of dextrose.

19. The process in accordance with claim 18 wherein the amount of browning liquid ranges from about 0.15 to about 0.3 wt. %, based on the weight of the breast.

20. The process in accordance with claim 18 further comprising the browning liquid pyrolysis product contains a masking agent or flavoring enhancing composition.

21. The process in accordance with claim 20 further comprising the browning liquid pyrolysis product contains from about 0.5 to about 15 wt. % turkey flavor or turkey broth or a mixture of the two.

22. The process in accordance with claim 16 wherein the energy source selectively heats the surface of the breast by creating an environment having a temperature from about 450° C. to about 650° C.

23. The process in accordance with claim 16 further comprising prior to exposing the meat product to the energy source, the temperature at the core of the meat product is less than about 5° C. and immediately after browning the meat product, the temperature at the core of the meat product is less than about 8° C.

24. The process in accordance with claim 23 wherein prior to exposing the meat product to the energy source, the temperature at the core of the meat product is less than about 5° C. and immediately after browning the meat product, the temperature at the core of the meat product is less than about 5° C.

25. The process in accordance with claim 1 wherein the shrinkage of the precooked, whole muscle meat product is less than 4 wt. % based on the initial weight of the meat product.

26. The process in accordance with claim 1 wherein the shrinkage of the precooked, whole muscle meat product is less than 1 wt. % based on the initial weight of the meat product.

27. The process in accordance with claim 16 wherein the shrinkage of the precooked, whole muscle meat product is less than 1 wt. % based on the initial weight of the meat product.

28. The process in accordance with claim 1 wherein the whole muscle meat product has protrusions on its surface caused by precooking in a net.

29. The process in accordance with claim 16 wherein the whole muscle meat product has protrusions on its surface caused by precooking in a net.

30. A process for browning precooked, whole muscle meat products comprising:
precooking a whole muscle meat product in a netting bag;
removing the bag;
coating a browning liquid pyrolysis product onto at least a portion of the surface of the precooked whole muscle meat product; and then
exposing the coated surface to an energy source and selectively heating the coated surface of the whole muscle meat product at a temperature and for a time sufficient to develop a golden-brown color on the exposed surface, without substantial shrinking the precooked, whole muscle meat product.
